(19) United States
(12) Patent Application Publication
(10) Pub. No.: US 2017/0123413 A1
(43) Pub. Date: May 4, 2017

(54) METHODS AND SYSTEMS FOR CONTROLLING AN UNMANNED AERIAL VEHICLE

(71) Applicant: Xiaomi Inc., Beijing (CN)

(72) Inventors: Hualin YE, Beijing (CN); Xin LIU, Beijing (CN); Yongfeng XIA, Beijing (CN)

(73) Assignee: Xiaomi Inc.

(21) Appl. No.: 15/166,138

(22) Filed: May 26, 2016

(30) Foreign Application Priority Data
Oct. 30, 2015 (CN) 201510727596.X

(51) Int. Cl. G05D 1/00; B64C 39/02; G01S 19/13

(52) U.S. Cl. CPC G05D 1/0011; G01S 19/13; B64C 39/024; B64C 2201/146; B64C 2201/141; B64C 2201/123

(57) ABSTRACT

A method for controlling an unmanned aerial vehicle (UAV) is provided. The UAV includes an external system configured to generate information about its surrounding environment and a communication system configured to provide a data link for transmission of the information to a remote controller associated with the UAV. The method comprises: determining whether a distance between the UAV and the remote controller exceeds a predetermined range; determining whether the UAV is capable of transmitting the information about its surrounding environment to the remote controller, the determination including determining whether at least one of the external system and the data link is in a normal state of operation; and after determining that the distance exceeds the predetermined range and that the UAV is not capable of transmitting the information to the remote controller, controlling the UAV to operate in a return mode.

### CROSS-REFERENCE TO RELATED APPLICATIONS

This application is based on and claims priority to Chinese Patent Application No. 201510727596.X, filed on Oct. 30, 2015, which is incorporated herein by reference in its entirety.

### TECHNICAL FIELD

The present disclosure generally relates to an unmanned aerial vehicle (UAV), and more particularly, to methods and systems for controlling a UAV.

### BACKGROUND

Currently, UAVs can be remotely controlled, by a user, at a distance that is beyond the visual range of the user. However, when the UAV is operated at such a distance from the user, it becomes difficult for the user to gauge a condition of the environment the UAV is in when controlling the UAV. As a result, the UAV can create hazards for other airborne objects (e.g., a plane, another UAV, etc.). The safety hazards are further exacerbated as the market of civilian UAVs has grown, and there is an increasing number of UAVs being operated at a distance beyond visual range for recreational uses.

### SUMMARY

In one aspect, a method for controlling an unmanned aerial vehicle (UAV) is provided. The UAV includes an external system configured to generate information about its surrounding environment and a communication system configured to provide a data link for transmission of the information to a remote controller associated with the UAV. The method comprises: determining whether a distance between the UAV and the remote controller exceeds a predetermined range; determining whether the UAV is capable of transmitting the information about its surrounding environment to the remote controller, the determination including determining whether at least one of the external system and the data link is in a normal state of operation; and after determining that the distance exceeds the predetermined range and that the UAV is not capable of transmitting the information to the remote controller, controlling the UAV to operate in a return mode.

In another aspect, a system for controlling an unmanned aerial vehicle (UAV) is presented. The UAV includes an external system configured to generate information about its surrounding environment and a communication system configured to provide a data link for transmission of the information to a remote controller associated with the UAV. The system comprises: a processor; and a memory for storing instructions executable by the processor; wherein the processor is configured to: determine whether a distance between the UAV and the remote controller exceeds a predetermined range; determine whether the UAV is capable of transmitting the information about its surrounding environment to the remote controller, the determination including determining whether at least one of the external system and the data link is in a normal state of operation; and after determining that the distance exceeds the predetermined range and that the UAV is not capable of transmitting the information to the remote controller, control the UAV to operate in a return mode.

In yet another aspect, a non-transitory computer-readable storage medium is provided. The non-transitory computer-readable storage medium stores instructions that, when executed by a processor of an unmanned aerial vehicle (UAV) including an external system configured to generate information about its surrounding environment and a communication system configured to provide a data link for transmission of the information to a remote controller associated with the UAV, causes the processor to perform a method of controlling the UAV, the method comprising: determining whether a distance between the UAV and the remote controller exceeds a predetermined range; determining whether the UAV is capable of transmitting the information about its surrounding environment to the remote controller, the determination including determining whether at least one of the external system and the data link is in a normal state of operation; and after determining that the distance exceeds the predetermined range and that the UAV is not capable of transmitting the information to the remote controller, controlling the UAV to operate in a return mode.

It should be understood that both the foregoing general description and the following detailed description are only exemplary and are not restrictive of the invention.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart illustrating a method for controlling a UAV, according to an exemplary embodiment.

FIG. 2 is a flow chart illustrating a method for controlling a UAV, according to another exemplary embodiment.

FIG. 3 is a block diagram of a system for controlling a UAV, according to an exemplary embodiment.

FIG. 4 is a block diagram of a system for controlling a UAV, according to another exemplary embodiment.

FIG. 5 is a system architecture diagram illustrating an apparatus in which embodiments of the present disclosure can be implemented.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

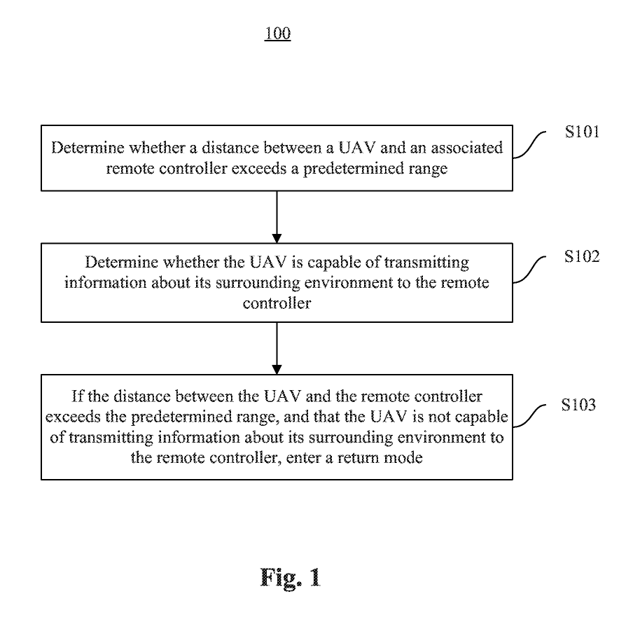

FIG. 1 is a flowchart illustrating a method 100 for controlling a UAV according to an exemplary embodiment. The method 100 can be performed by a control system of a UAV configured to communicate with a remote controller (which can be a mobile terminal). As shown in FIG. 1, the method 100 includes steps S101 to S103.

In step S101, the control system determines whether a distance between the UAV and an associated remote controller exceeds a predetermined range. The predetermined range can be set based on, for example, an average human visual range, the visual range of the operator of the UAV, or other criteria.

In step S102, the control system determines whether the UAV is capable of transmitting information about its surrounding environment to the remote controller. For example, the UAV may include an external system configured to generate data about a surrounding environment of the UAV, and a communication system to provide a data return link for transmitting the data back to the control system. The determination of whether the UAV is capable of transmitting information about its surrounding environment back to the remote controller may include, for example, determining whether at least one of the data return link or the external system is not in a normal state of operation.

In step S103, if the control system determines that the distance between the UAV and the remote controller exceeds the predetermined range, and that the UAV is not capable of transmitting information about its surrounding environment to the remote controller (e.g., based on a determination that at least one of the data return link or the external system is not in a normal state of operation), the control system can control various components of the UAV (e.g., motor(s), rudder(s), etc.) to cause the UAV to operate in a return mode. In the return mode, the control system may control the UAV to fly towards the remote controller, or towards another predetermined location.

Consistent with embodiments of the present disclosure, in a case where the distance between the UAV and the remote controller exceeds the predetermined range, and the UAV is not capable of transmitting information about its surrounding environment to the remote controller, an operator may be unable to control the UAV effectively due to lack of information about its surrounding environment. By controlling the UAV to operate in a return mode after determining that the operator does not have access to the information about the UAV's surrounding environment, it becomes less likely that the UAV will collide with other airborne objects (e.g., a plane, another UAV, etc.). As a result, the operation safety of the UAV can be improved.

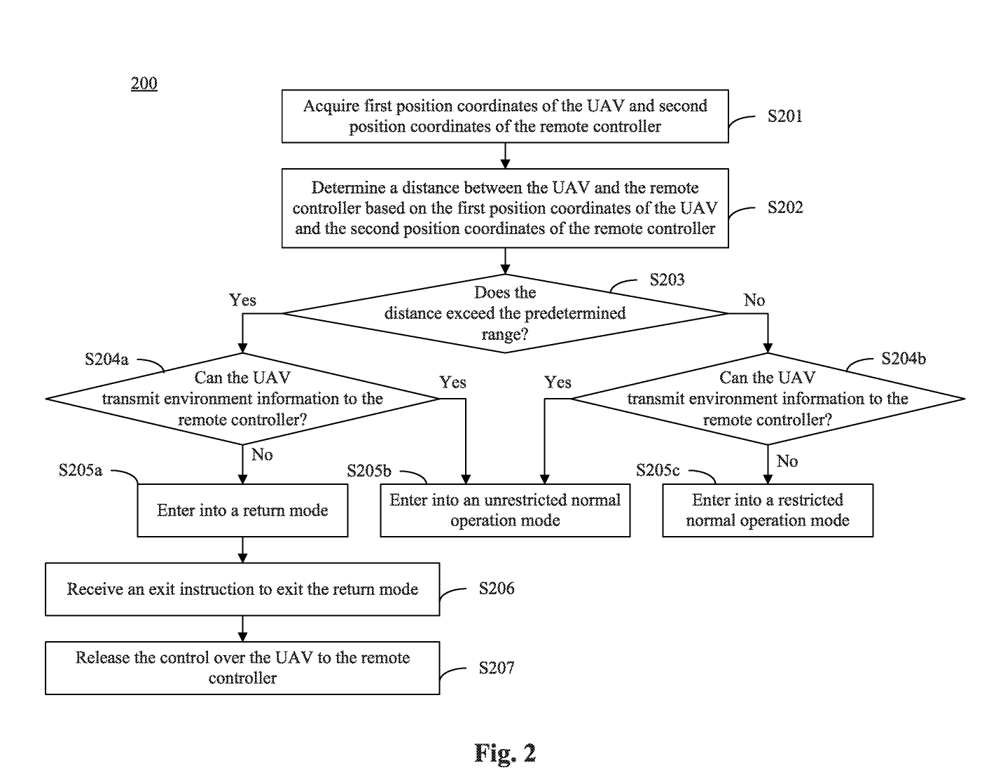

FIG. 2 is a flowchart illustrating a method 200 for controlling a UAV according to an exemplary embodiment. The method 200 can be performed by a control system of a UAV configured to communicate with a remote controller (which can be part of a mobile terminal). The UAV may include an external system configured to generate information about a surrounding environment of the UAV. The external system may include at least one of: a camera, an infrared sensor system, and a depth-of-field camera (DOF Camera). As shown in FIG. 2, the method 200 includes steps S201 to S207.

In step S201, the control system acquires first position coordinates of the UAV and second position coordinates of the remote controller. Both the first position coordinates and the second position coordinates can be acquired, respectively, from a first positioning system associated with the UAV and a second positioning system associated with the remote controller. The first and second positioning systems can include, for example, a global positioning system (GPS), a Base Station Positioning System, a Wireless Fidelity (WiFi) Positioning System, etc.

In some embodiments, the remote controller can transmit its second position coordinates, through a control channel, to the UAV. The control channel can be for transmission of operation instructions from the remote controller to the UAV.

In step S202, the control system determines a distance between the UAV and the remote controller based on the first position coordinates of the UAV and the second position coordinates of the remote controller.

As an illustrative example, if the first position coordinates of the UAV are (a1, b1), and the second position coordinates of the remote controller are (a2, b2), the control system can determine the distance between the UAV and the remote controller based on a distance formula.

In step S203, the control system determines the distance between the UAV and the remote controller exceeds a predetermined range. The predetermined range can be set based on, for example, an average human visual range, the visual range of the operator of the UAV, or other criteria.

In steps S204a and S204b, the control system also determines whether the UAV is capable of transmitting information about its surrounding environment to the remote controller. For example, the UAV may include an external system configured to generate information about a surrounding environment of the UAV, and a communication system to provide a data return link for transmitting the data about the environment to the remote controller. The determination of whether the UAV is capable of transmitting information about its surrounding environment back to the remote controller may include, for example, determining whether the data return link is in a normal state of operation. The data return link can be independent from the control channel for transmission of operation instructions and the remote controller position coordinates. As a result, the transmission of operation instructions and the remote controller position coordinates to the control system of the UAV can remain unaffected, even if the data return link is not in a normal state of operation.

Further, the external system may include at least one of a camera, an infrared sensor system, and a depth-of-field camera.

In a case where the external system includes a camera, the camera can capture images of the UAV's surrounding environment. If the external system and the data return link are in a normal state of operation, the remote controller (e.g., a mobile terminal) can receive data of the captured images of the camera (e.g., of a surrounding environment of the UAV) via the data return link, and provide the data to the operator of the UAV.

In a case where the external system includes an infrared sensor system or a depth-of-field camera, the infrared sensor system, or the depth-of-field camera, may detect an airborne object near the UAV, and provide data about a relative position between the UAV and the detected airborne object. If the external system and the data return link are in a normal state of operation, the remote controller can receive data of the relative position via the data return link, and provide the data to the operator of the UAV.

In some embodiments, in order to determine whether the data return link is in a normal state of operation (e.g., in steps S204a and S204b), the control system may transmit, periodically, a handshake request signal to the remote controller via the data return link, and monitor for a reply signal from the remote controller. If the control system determines that a reply signal is not received within a predetermined time after the transmission of the handshake request signal, the control system may determine that at least the data return link is not in a normal state of operation.

If the control system determines that the UAV is not capable of transmitting the information about its surrounding environment to the remote controller (in step S204a), and that the distance between the UAV and the remote controller exceeds the predetermined range (in step S203), the control system can control various components of the UAV (e.g., the motor(s), the rudder(s), etc.) to cause the UAV to operate in a return mode (step S205a). In the return mode, the control system controls the UAV to fly towards the remote controller, or towards another predetermined location.

If the control system determines that the UAV is capable of transmitting the information about its surrounding environment to the remote controller (in either step S204a or step S204b), the control system proceeds to step S205b and enters an unrestricted normal operation mode. In the unrestricted normal operation mode, the control system may receive a flight operation instruction from the remote controller, and control various components of the UAV to cause the UAV to operate according to the flight operation instruction. The flight operation of the UAV may include, for example, turning left, turning right, descending, elevating, accelerating, decelerating, etc., and any combination thereof.

In some embodiments, the control system may exit from the return mode based on a determination that the distance between the UAV and the remote controller is within the predetermined range. The switching from the return mode to the normal operation mode includes the following steps S206-S207.

In step S206, the control system receives, from the remote controller, an exit instruction to exit the return mode.

In step S207, in response to the exit instruction, the control system releases the control over the UAV to the remote controller, and controls the UAV according to flight operation instructions received from the remote controller.

It is understood that the relative timing between steps S201-S203 and step S204a and S204b is not limited to the description above. In some cases, steps S201-S203 and steps S204a and S204b may be performed at substantially the same time. In some cases, steps S201-S203 may be carried out first, followed by steps S204a and S204b when the distance between the UAV and the remote controller is determined to exceed the predetermined range. In some cases, one of steps S204a or S204b may be carried out first, followed by steps S201-S203, when the data return link of the external system of the UAV is determined to be not in a normal state of operation.

Further, if the distance between the UAV and the remote controller is determined to be within the predetermined range from the remote controller (in step S203—“no”), and the UAV is not capable of transmitting information about its surrounding environment to the remote controller (i.e., in step S204b—“no”), the control system proceeds to step S205c to enter a restricted normal operation mode, in which the control system still controls the flight operation of the UAV based on flight operation instructions from the remote controller, but also restricts a flight operation of the UAV such that the UAV remains within the predetermined range from the remote controller. The restricted normal operation mode can be triggered when the UAV is moving (or about to move) beyond the predetermined range, or when the UAV is taking off, to improve the operation safety of the UAV. In some embodiments, the restricted normal operation mode can also be triggered when the control system receives a restriction instruction from the remote controller.

After entering the restricted normal operation mode, the control system can restrict a flight operation of the UAV such that it remains within the predetermined range from the remote controller. In some embodiments, during the restricted normal operation mode, the control system can determine a distance between the UAV and the remote controller. If the distance is determined to be equal to or exceed the predetermined range, the control system may control the UAV to fly towards the remote controller.

With embodiments of the present disclosure, in a case where the distance between the UAV and the remote controller exceeds the predetermined range, and that the UAV is not capable of transmitting information about its surrounding environment to the remote controller, an operator may be unable to control the UAV effectively due to lack of information about its surrounding environment. By controlling the UAV to operate in a restricted normal operation mode after determining that the operator does not have access to the information about the UAV's surrounding environment, it becomes less likely that the UAV will collide with other airborne objects (e.g., a plane, another UAV, etc.). As a result, the operation safety of the UAV can be improved.

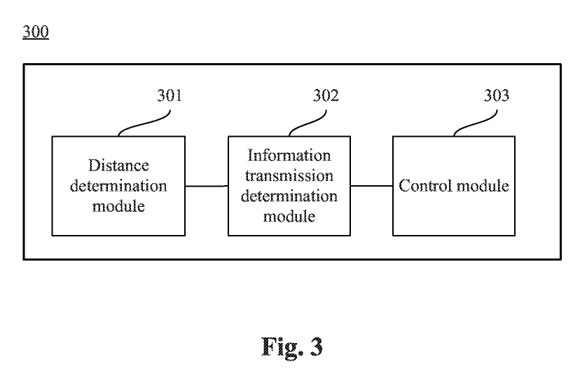

FIG. 3 is a block diagram of a system 300 for controlling a UAV, according to an exemplary embodiment. As shown in FIG. 3, the system 300 includes a distance determination module 301, an information transmission determination module 302, and a control module 303.

The distance determination module 301 is configured to determine whether a distance between a UAV and an associated remote controller exceeds a predetermined range. The predetermined range can be set based on, for example, an average human visual range, or based on the visual range of the operator of the UAV. The remote controller can be a part of a mobile terminal.

In some embodiments, the distance determination module 301 may be configured to perform at least a part of step S101 of FIG. 1.

The information transmission determination module 302 is configured to determine whether the UAV is capable of transmitting information about its surrounding environment to the remote controller. The UAV may include an external system configured to generate data about a surrounding environment of the UAV, and a communication system to provide a data return link for transmitting the data back to the control system. The determination of whether the UAV is capable of transmitting information about its surrounding environment back to the remote controller may include, for example, determining whether one of the data return link or the external system is not in a normal state of operation. In some embodiments, the information transmission determination module 302 may be configured to perform at least a part of step S102 of FIG. 1.

The control module 303 is configured to, based on a determination that the distance between the UAV and the remote controller exceeds the predetermined range, and determine that the UAV is not capable of transmitting information about its surrounding environment to the remote controller, control various components of the UAV (e.g., the motor(s), the rudder(s), etc.) to cause the UAV to operate in a return mode. In the return mode, the UAV may fly towards the remote controller, or towards another predetermined location. In some embodiments, the control module 303 may be configured to perform at least a part of step S103 of FIG. 1.

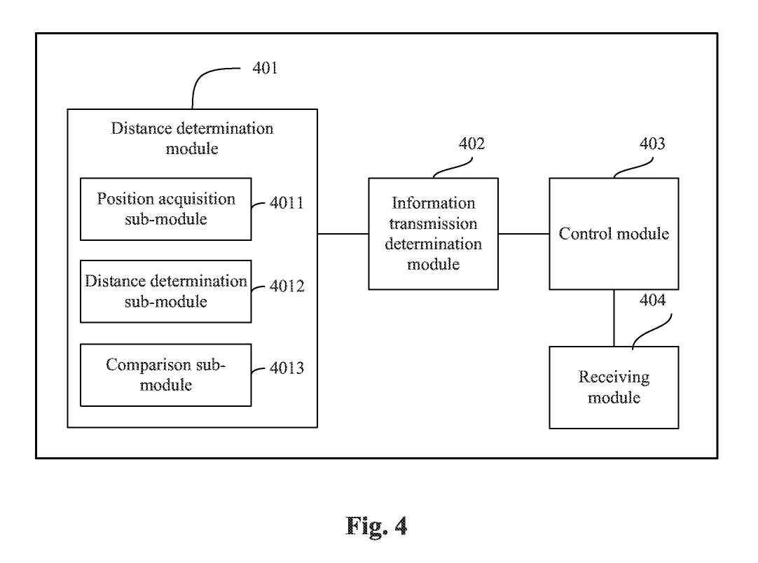

FIG. 4 is a block diagram of a system 400 for controlling a UAV, according to an exemplary embodiment. As shown in FIG. 4, the system 400 includes a distance determination module 401, an information transmission determination module 402, a control module 403, and a receiving module 404. As discussed below, the receiving module 404 receives an instruction from a remote controller associated with the UAV, and provides the instruction to the control module 403.

The distance determination module 401 is configured to determine whether a distance between a UAV and the remote controller exceeds a predetermined range. The remote controller can be a part of a mobile terminal. As shown in FIG. 4, the distance determination module 401 includes a position acquisition sub-module 4011, a distance determination sub-module 4012, and a comparison sub-module 4013.

The position acquisition sub-module 4011 is configured to acquire first position coordinates of the UAV and second position coordinates of the remote controller. Both the first position coordinates and the second position coordinates can be acquired, respectively, from a first positioning system associated with the UAV and a second positioning system associated with the remote controller. The first and second positioning systems can include, for example, a global positioning system (GPS), a Base Station Positioning System, a Wireless Fidelity (WiFi)

Positioning System, etc. In some embodiments, the position acquisition sub-module 4011 can perform at least a part of step S201 of FIG. 2.

The distance determination sub-module 4012 is configured to determine a distance between the UAV and the remote controller based on the first position coordinates of the UAV and the second position coordinates of the remote controller acquired by the position acquisition sub-module 4011. In some embodiments, the distance determination sub-module 4012 can perform at least a part of step S202 of FIG. 2.

The comparison sub-module 4013 is configured to determine whether a distance between the UAV and the remote controller, determined by distance determination sub-module 4012, exceeds a predetermined range. The predetermined range can be set based on, for example, an average human visual range, or based on the visual range of the operator of the UAV. In some embodiments, the comparison sub-module 4013 can perform at least a part of step S203 of FIG. 2.

The information transmission determination module 402 is configured to determine whether the UAV is capable of transmitting data about its surrounding environment to the remote controller. The UAV may include an external system configured to generate data of information about a surrounding environment of the UAV. The external system may include at least one of: a camera, an infrared sensor system, and a depth-of-field camera (DOF Camera). The UAV may include a communication system to provide a data return link for transmitting the data back to the control system. The determination of whether the UAV is capable of transmitting information about its surrounding environment back to the remote controller may include, for example, determining whether the data return link (and/or the external system) is in a normal state of operation. In some embodiments, the comparison sub-module 4013 can perform at least a part of step S204a and step S204b of FIG. 2.

The control module 403 is configured to determine a mode of operation for the UAV based on a determination of whether the distance between the UAV and the remote controller exceeds the predetermined range (as determined by the comparison sub-module 4013) and a determination of whether the UAV is capable of transmitting data about its surrounding environment to the remote controller (as determined by the information transmission determination module 402). In some embodiments, the control module 403 can perform steps S205a, S205b, and S205c of FIG. 2.

For example, if the UAV is determined to be not capable of transmitting the information about its surrounding environment to the remote controller, and that the distance between the UAV and the remote controller exceeds the predetermined range, the control module 403 can control various components of the UAV (e.g., the motor(s), the rudder(s), etc.) to cause the UAV to operate in a return mode. In the return mode, the control module 403 can control the UAV to fly towards the remote controller, or towards another predetermined location. The control module 403 may also receive an exit instruction to exit the return mode. The exit instruction can be provided by the receiving module 404 which receives the instruction from the remote controller. In response to the exit instruction, the control module 403 can release the control over the UAV to the remote controller, and can control the UAV according to one or more flight operation instructions. The flight operation instructions can also be provided by the receiving module 404 which receives the instruction from the remote controller. In some embodiments, the control module 403 can perform steps S206 and S207 of FIG. 2.

Also, if the UAV is determined to be capable of transmitting the information about its surrounding environment to the remote controller, the control module 403 may enter an unrestricted normal operation mode. Under the unrestricted normal operation mode, the control module 403 may receive a flight operation instruction provided by the receiving module 404 which receives the instruction from the remote controller, and control various components of the UAV to cause the UAV to operate according to the flight operation instruction. The flight operation of the UAV may include, for example, turning left, turning right, descending, elevating, accelerating, decelerating, etc., and any combination thereof. In some embodiments, the receiving module 404 is configured to receive the flight operation instruction from the remote controller, and provide the flight operation instruction to the control module 403.

Further, if the distance between the UAV and the remote controller is determined to be within the predetermined range from the remote controller, and the UAV is not capable of transmitting information about its surrounding environment to the remote controller, the control module 403 may enter a restricted normal operation mode, in which the control module 403 can control the flight operation of the UAV based on flight operation instructions from the remote controller, but also restrict a flight operation of the UAV such that it remains within the predetermined range from the remote controller. The restrictive normal operation mode can be triggered when the UAV is moving (or about to move) beyond the predetermined range, or when the UAV is taking off, to improve the operation safety of the UAV. In some embodiments, the restricted normal operation mode can also be triggered when the control module 403 receives a restriction instruction from the remote controller.

After entering the restricted normal operation mode, the control module 403 can restrict a flight operation of the UAV such that it remains within the predetermined range from the remote controller. In some embodiments, during the restricted normal operation mode, the control module 403 can determine a distance between the UAV and the remote controller. If the distance is determined to be equal to or exceed the predetermined range, the control module 403 may control the UAV to fly towards the remote controller.

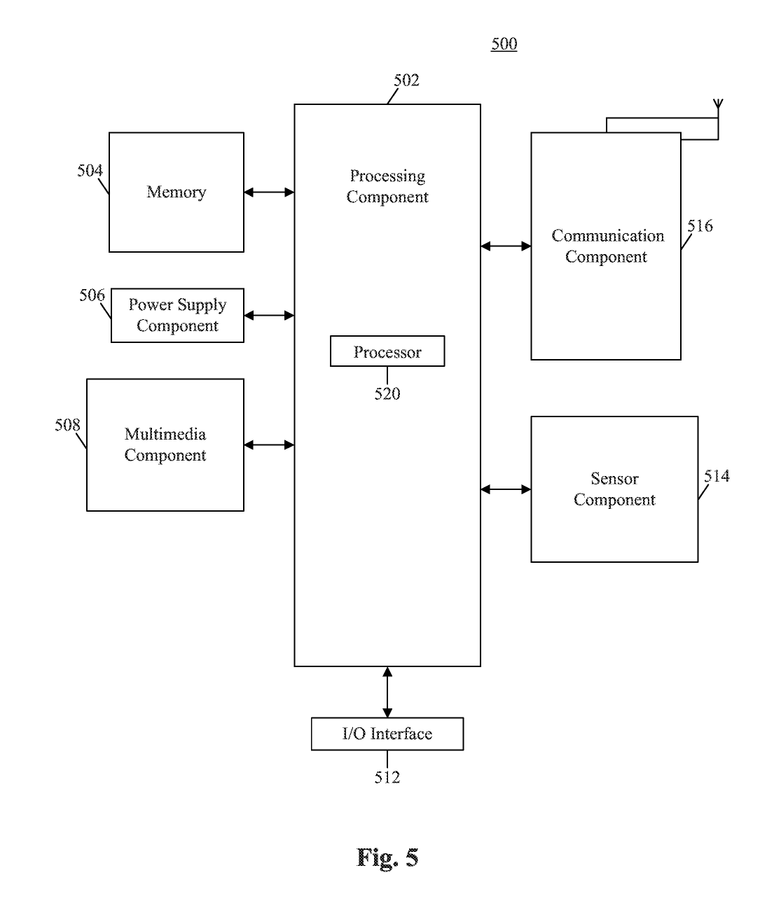

FIG. 5 is a system architecture diagram of an apparatus 500 for controlling a UAV according to an exemplary embodiment. Apparatus 500 can be part of a control system that controls a flight operation of the UAV. Referring to FIG. 5, the apparatus 500 includes one or more of the following components: a processing component 502, a memory 504, a power supply component 506, a multimedia component 508, an input/output (I/O) interface 512, a sensor component 514, and a communication component 516.

The processing component 502 typically controls overall operations of the apparatus 500, such as the operations associated with data communications, camera operations, and recording operations. The processing component 502 may include one or more processors 520 to execute instructions to perform all or part of the steps in the above described methods. Moreover, the processing component 502 may include one or more modules which facilitate the interaction between the processing component 502 and other components. For instance, the processing component 502 may include a multimedia module to facilitate the interaction between the multimedia component 508 and the processing component 502.

The memory 504 is configured to store various types of data to support the operation of the apparatus 500. Examples of such data include instructions for any applications or methods operated on the apparatus 500. The memory 504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk. The memory 504 can include a non-transitory computer readable medium to store instructions that correspond to any of the modules and sub-modules of FIGS. 3 and 4. The instructions, when executed by the one or more processors 520 of the processing component 502, can also cause the one or more processors 520 to perform, for example, the methods 200 and 300 of FIGS. 2 and 3.

The power supply component 506 provides power to various components of the device 500. The power supply component 506 may include a power management system, one or more power sources, and any other components associated with the generation, management, and distribution of power in the device 500.

The multimedia component 508 includes at least one camera. When the apparatus 500 is in an operation mode, such as a photographing mode or a video mode, the camera may receive external multimedia data. Each camera may be a fixed optical lens system or have focal length and optical zoom capability.

The I/O interface 512 provides an interface between the processing component 502 and peripheral interface modules, such as a keyboard, a click wheel, buttons, and the like.

The sensor component 514 includes one or more sensors to provide status assessments of various aspects of the apparatus 500. For instance, the sensor component 514 may generate information about an environment in which the apparatus 500 is located. The sensor component 514 may include an infrared sensor configured to detect distances between the apparatus 500 and another object (e.g., an airborne object adjacent to the UAV when it is flying). The sensor component 514 may also include a light sensor, such as a CMOS or CCD image sensor, for use in imaging applications. In some embodiments, the sensor component 514 may also include an accelerometer sensor, a gyroscope sensor, a magnetic sensor, a pressure sensor, or a temperature sensor.

The communication component 516 is configured to facilitate communication, wired or wirelessly, between the apparatus 500 and other devices. The apparatus 500 can access a wireless network based on a communication standard, such as WiFi, 2G, or 3G, or a combination thereof. In one exemplary embodiment, the communication component 516 receives a broadcast signal or broadcast associated information from an external broadcast management system via a broadcast channel In one exemplary embodiment, the communication component 516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for controlling an unmanned aerial vehicle (UAV), the UAV including an external system configured to generate information about its surrounding environment and a communication system configured to provide a data link for transmission of the information to a remote controller associated with the UAV, the method comprising:
determining whether a distance between the UAV and the remote controller exceeds a predetermined range;
determining whether the UAV is capable of transmitting the information about its surrounding environment to the remote controller, the determination including determining whether at least one of the external system and the data link is in a normal state of operation; and
after determining that the distance exceeds the predetermined range and that the UAV is not capable of transmitting the information to the remote controller, controlling the UAV to operate in a return mode.

2. The method of claim 1, wherein the determining whether a distance between the UAV and the remote controller exceeds a predetermined range comprises:
acquiring first position coordinates of the UAV;
acquiring second position coordinates of the remote controller;
determining the distance between the UAV and the remote controller based on the first and second position coordinates; and
determining whether the distance exceeds the predetermined range.

3. The method of claim 2, wherein the first position coordinates are acquired from a first positioning system of the UAV;
wherein the second position coordinates are acquired from a second positioning system of the remote controller; and
wherein the first and second positioning systems comprise at least one of: a Global Positioning System, a Base Station Positioning System, and a Wireless Fidelity Positioning System.

4. The method of claim 1, wherein the predetermined range is determined based on at least one of an average human visual range and a visual range of an operator of the UAV.

5. The method of claim 1, wherein the external system comprises at least one of a camera, an infrared sensor system, and a depth-of-field camera.

6. The method of claim 1, wherein the controlling the UAV to operate in a return mode comprises controlling the UAV to fly towards one of the remote controller or a predetermined location.

7. The method of claim 1, further comprising:
receiving an exit instruction to exit the return mode; and
after receiving the exit instruction, controlling the UAV based on one or more flight operation instructions received from the remote controller.

8. The method of claim 1, further comprising:
receiving a restriction instruction to enter a restricted mode; and
controlling the UAV to operate in the restricted mode to fly within the predetermined range from the remote controller.

9. The method of claim 8, wherein the controlling the UAV to operate in the restricted mode comprises:
after determining that the distance exceeds the predetermined range, controlling the UAV to fly towards the remote controller.

10. A system for controlling an unmanned aerial vehicle (UAV), the UAV including an external system configured to generate information about its surrounding environment and a communication system configured to provide a data link for transmission of the information to a remote controller associated with the UAV, the system comprising:
a processor; and
a memory for storing instructions executable by the processor;
wherein the processor is configured to:
determine whether a distance between the UAV and the remote controller exceeds a predetermined range;
determine whether the UAV is capable of transmitting the information about its surrounding environment to the remote controller, the determination including determining whether at least one of the external system and the data link is in a normal state of operation; and
after determining that the distance exceeds the predetermined range and that the UAV is not capable of transmitting the information to the remote controller, control the UAV to operate in a return mode.

11. The system of claim 10, wherein the determining whether a distance between the UAV and the remote controller exceeds a predetermined range comprises the processor being configured to:
acquire first position coordinates of the UAV;
acquire second position coordinates of the remote controller;
determine the distance between the UAV and the remote controller based on the first and second position coordinates; and
determine whether the distance exceeds the predetermined range.

12. The system of claim 11, wherein the first position coordinates are acquired from a first positioning system of the UAV;
wherein the second position coordinates are acquired from a second positioning system of the remote controller; and
wherein the first and second positioning systems comprise at least one of: a Global Positioning System, a Base Station Positioning System, and a Wireless Fidelity Positioning System.

13. The system of claim 10, wherein the predetermined range is determined based on at least one of an average human visual range and a visual range of an operator of the UAV.

14. The system of claim 10, wherein the external system comprises at least one of a camera, an infrared sensor system, and a depth-of-field camera.

15. The system of claim 10, wherein the controlling the UAV to operate in a return mode comprises the processor being configured to control the UAV to fly towards one of the remote controller or a predetermined location.

16. The system of claim 11, wherein the processor is configured to:
receive an exit instruction to exit the return mode; and
after receiving the exit instruction, control the UAV based on one or more flight operation instructions received from the remote controller.

17. The system of claim 11, wherein the processor is configured to:
receive a restriction instruction to enter a restricted mode; and
control the UAV to operate in the restricted mode to fly within the predetermined range from the remote controller.

18. The system of claim 17, wherein the controlling the UAV to operate in the restricted mode comprises the processor being configured to:
after determining that the distance exceeds the predetermined range, controlling the UAV to fly towards the remote controller.

19. A non-transitory computer-readable storage medium storing instructions that, when executed by a processor of an unmanned aerial vehicle (UAV) including an external system configured to generate information about its surrounding environment and a communication system configured to provide a data link for transmission of the information to a remote controller associated with the UAV, causes the processor to perform a method of controlling the UAV, the method comprising:
determining whether a distance between the UAV and the remote controller exceeds a predetermined range;
determining whether the UAV is capable of transmitting the information about its surrounding environment to the remote controller, the determination including determining whether at least one of the external system and the data link is in a normal state of operation; and
after determining that the distance exceeds the predetermined range and that the UAV is not capable of transmitting the information to the remote controller, controlling the UAV to operate in a return mode.
